(19) United States
(12) Patent Application Publication
(10) Pub. No.: US 2024/0353571 A1
(43) Pub. Date: Oct. 24, 2024

(54) Method for Detecting GNSS Spoofing in a GNSS Receiver of a Localization System

(71) Applicant: Robert Bosch GmbH, Stuttgart (DE)

(72) Inventors: Tomasz Bien, Ludwigsburg (DE); Jens Strobel, Freiberg Am Neckar (DE); Marco Limberger, Appenweier-Urloffen (DE)

(21) Appl. No.: 18/693,199

(22) PCT Filed: Aug. 8, 2022
(86) PCT No.: PCT/EP2022/072226

§ 371 Date: May 29, 2024

(30) Foreign Application Priority Data
Sep. 23, 2021 (DE) 10 2021 210 599.8

(51) Int. Cl. G01S 19/21

(52) U.S. Cl. CPC G01S 19/215

(57) ABSTRACT

A method for detecting global navigation satellite system (“GNSS”) spoofing in a GNSS receiver of a localization system includes a) detecting ephemeris data or almanac data of a GNSS satellite in a time step, and b) detecting ephemeris data or almanac data of the same GNSS satellite in a subsequent time step. The method also includes c) comparing the ephemeris data or almanac detected in step a) with the ephemeris data or almanac data detected in step b), and d) detecting the GNSS spoofing when the ephemeris data or almanac data detected in step a) and in step b) deviate from each other.

The present invention relates to a method for detecting GNSS spoofing in a GNSS receiver of a localization system. Also disclosed are a control device, a computer program, a machine-readable storage medium, a localization system for a vehicle, and a method for operating the localization system. The invention can in particular be used in GNSS-based localization systems for autonomous or semi-autonomous driving.

### PRIOR Art

A global navigation satellite system (abbreviation: GNSS) is a system for position determination and navigation on Earth and in the air by receiving navigation satellite signals. Using a localization system with a GNSS receiver, an object equipped with the localization system can be positioned and navigated.

However, nowadays the navigation satellite signals can be falsified without great effort using inexpensive hardware and open-source software, for example, so that the object can be manipulated using the falsified navigation satellite signals. This is known as GNSS spoofing and is particularly important for autonomous driving.

This is because autonomous driving places particularly high demands on security and integrity (or correctness of the geolocation information, e.g. correctness of the accuracy information) in addition to positioning accuracy. The security of GNSS-based positioning is particularly relevant in the context of safety-critical automated driving functions in order to protect the geolocation from manipulation by falsified navigation satellite signals. A detection of GNSS spoofing is therefore considered particularly necessary for autonomous driving.

### DISCLOSURE OF THE INVENTION

Proceeding therefrom, the object of the present invention is to alleviate or at least partially solve the problems described in relation to the prior art.

Based on this, a particularly advantageous method for detecting GNSS spoofing in a GNSS receiver of a localization system is described here.

A method for detecting GNSS spoofing in a GNSS receiver of a localization system is described here, comprising the following steps:
a) detecting ephemeris data or almanac data of a GNSS satellite in a time step,
b) detecting ephemeris data or almanac data of the same GNSS satellite in a subsequent time step,
c) comparing the ephemeris data detected in step a) with the ephemeris data or almanac data detected in step b), and
d) detecting GNSS spoofing if the ephemeris data or almanac data detected in step a) and in step b) deviate from each other.

The method described may generally be performed with ephemeris data or with almanac data. Both ephemeris data and almanac data are generally similarly structured. In contrast to ephemeris data, almanac data change less frequently. For performing the comparison in step c), the differences between ephemeris data and almanac data are not relevant. For the described method, it is important that in step c) data should always be compared that are similar and that should then be identical if everything is in order and there is no spoofing. This means that ephemeris data are compared with ephemeris data or almanac data are compared with almanac data. For the sake of simplicity, only ephemeris data are mentioned in the following. This always refers to almanac data as well.

The method is particularly preferable if a time stamp included in the ephemeris data or almanac data detected in step a) is also determined in step a) and if a time stamp included in the ephemeris data or almanac data detected in step b) is also determined in step b), wherein in step d), as an additional condition for GNSS spoofing, it is checked whether the time stamp determined in step a) and the time stamp determined in step b) match.

Only ephemeris data or almanac data with the same time stamp are identical. For this reason, it is advantageous to discard the data for the detection of spoofing if it is already clear from the time stamps that the data may not be identical, although they are correct. Preferably, the time stamps determined in step a) and b) are also checked for plausibility in order to prevent the time stamps from being deliberately manipulated in order to bypass the spoofing detection in step d).

Checking the match of the time stamps is preferably an additional condition for detecting a spoofing situation. This condition must be satisfied for a spoofing situation to be detected in step d). In design variants of the method, the matching of the time stamps is a prerequisite for the comparison of the ephemeris data or the almanac data in step c) to occur at all.

The method described is particularly suitable for autonomous driving. Autonomous driving here refers in particular to the movement of vehicles, mobile robots and driverless transportation systems (e.g. motor vehicles, aircraft, ships) that behave largely autonomously by means of a GNSS receiver and based on global navigation satellite systems (GNSS). It is particularly advantageous if a self-driving motor vehicle with a localization system is equipped with such a GNSS receiver for carrying out the described method.

The localization system may be a GNSS-based or a GNSS and INS-based localization system that detects GNSS satellites in its field of view, receive GNSS signals, and position itself based on received GNSS signals.

The term “GNSS spoofing” refers in particular to the transmission of deliberately manipulated GNSS spoofing signals in order to manipulate the calculated time and/or location in a GNSS-based localization system. The GNSS spoofing signal is a deception signal that can simulate a GNSS signal transmitted by a GNSS satellite and, in particular comprise false ephemeris data. The evaluation of the GNSS spoofing signal therefore provides an incorrect positioning.

GNSS is the abbreviation for Global Navigation Satellite Systems (GPS, GLONASS, Galileo, and Beidou). Each GNSS has a large number of GNSS satellites (e.g. Galileo with 28 satellites, GPS with 24 satellites), which are evenly distributed in the sky or orbit and move according to a predetermined motion pattern.

Each GNSS satellite transmits GNSS navigational messages continuously and frame by frame. To transmit a full GNSS navigational message, it typically takes several seconds (e.g., 30 seconds for GPS). Thus, each GNSS satellite transmits GNSS navigation messages one after the other in the form a frame.

Each GNSS navigation message (i.e., each frame) includes the current ephemeris data of the GNSS satellite and a time at which the GNSS navigation message was transmitted. The ephemeris data includes the path data and the path correction data of the GNSS satellite, and the position of the GNSS satellite can be calculated on this basis. Moreover, the propagation speed of the GNSS navigational message in the form of an electromagnetic wave is known. Any relativistic effects on the propagation speed can be calculated and considered. Thus, the distance between the GNSS satellite and the localization system may be calculated according to the distribution time (i.e., time delay). Thus, positioning of the localization system can be determined by receiving at least four GNSS navigation messages from four different navigation satellites of the same GNSS.

The ephemeris data of each GNSS satellite is also updated regularly (e.g., with GPS approximately every two hours). In other words, the ephemeris data, in particular the payload included in the ephemeris data, such as path data and path correction data, will always remain the same after an update and before the next update (i.e., in the validity period), while with GNSS spoofing, a falsified GNSS navigation message may include significantly different ephemeris data. This forms the basis for performing the described method.

According to step a), the ephemeris data of a GNSS satellite is detected in a time step. This means that the localization system detects a GNSS satellite and receives a GNSS navigation message transmitted by the GNSS satellite with the current ephemeris data decoded into binary codes by the localization system.

The time step is preferably the initial time step for tracking the GNSS satellite. In other words, once the localization system receives GNSS signals from a GNSS satellite, the described method is immediately started from step a) to step c), and the method is then repeated. For example, the length of the time step may correspond to the duration in which the GNSS navigation message has been fully transmitted. For example, GPS may take 30 seconds.

According to step b), the ephemeris data of the same GNSS satellite is detected in a subsequent time step. This means that the localization system detects the ephemeris data in a subsequent time step as described in step a) while taking the GNSS satellite into account.

As further described above, a GNSS navigation message with the current ephemeris data is sent and received in each time step. The subsequent time step may be the second, third, or any other time step after the time step in step a), however, it must be within the validity period of the ephemerides.

It is preferred if the subsequent time step in step b) is the second time step, which directly follows the time step in step a). Thus, the ephemeris data of the two GNSS navigation messages detected in succession can be compared with each other, thereby enabling GNSS spoofing to be detected in a timely manner. This is advantageous for real-time detection of GNSS spoofing.

The detection of spoofing need not necessarily be based solely on the described comparison of ephemeris data. If necessary, further methods for detecting spoofing may be used. In design variants, it is possible that if the ephemeris data detected in step a) and in step b) deviate from each other, only one flag is generated which, for example, and possibly in conjunction with other flags and/or parameters, represents a probability that there is a spoofing situation, wherein said flag is taken into account in a (higher-level) GNSS spoofing detection in step d) in addition to other flags and/or parameters in order to ultimately detect a spoofing scenario.

It is also contemplated that the subsequent time step in step b) is any time step within the validity period of the ephemerides. It is advantageous if the method described is used as redundancy and combined with other security measures.

In step c), the ephemeris data detected in step a) is compared with the ephemeris data detected in step b). In particular, the payload data included in the ephemeris data, for example satellite path data and satellite path correction data, are compared with each other. It is particularly preferable if the ephemeris data from step a) and step b) are compared with each other by a digital comparator bit by bit. No complex algorithms are required for this purpose, and in particular no further data processing of the ephemeris data is necessary before the comparison can take place.

In step d), GNSS spoofing is detected if the ephemeris data detected in step a) and in step b) deviate from each other. This may mean that the bit level deviation can already index GNSS spoofing. For this purpose, it is particularly preferred if the ephemeris data from step a) and step b) are compared to each other taking into account the validity period of the ephemerides. During periods in which a change in the ephemeris data is expected, the described method is preferably suspended or the method is performed over such periods, but no spoofing is detected in step d) if a deviation of the ephemeris data determined in step a) and in step b) occurs.

Although the steps herein are denoted by the letters a) to d) in a specific order, it is not necessary to always adhere to this order. For example, the individual steps, in particular step a) to step b) can often be repeated independently of each other and/or can also sometimes be omitted in a case of repetition. It is possible that the steps are performed at least partially overlapping in time.

With the described method, at least the following two GNSS spoofing scenarios can be detected if the spoofer falsifies the ephemeris data as part of so-called loosely synchronized or tightly synchronized spoofing:

GNSS spoofing scenario A: Start of GNSS spoofing (i.e. transition from non-spoofing to spoofing)
i. Non-spoofed ephemeris data is received and stored by the localization system,
ii. The spoofer begins to send out simulated falsified ephemeris data that overlap with or replace the non-falsified ephemeris data.
iii. The falsified ephemeris data is decoded and compared with the non-falsified ephemeris data bit by bit.
iv. If there is a difference, the localization system detects a GNSS spoofing threat and can take appropriate action.

GNSS spoofing scenario B: Loosing-Regaining from spoofing (i.e. transition from spoofing to non-spoofing e.g. change in distance between the localization system and the spoofer)
i. The spoofer sends simulated spoofed ephemeris data that intersect with or replace the non-spoofed ephemeris data.
ii. The non-spoofed ephemeris data are received and stored by the localization system when the non-spoofed ephemeris data overlap with the spoofed ephemeris data.
iii. The localization system can detect a difference by comparing the two ephemeris data and thus a GNSS spoofing threat and take appropriate action.

In order to perform the described method, it only requires an additional memory, an additional digital comparator, and a software adjustment without complex algorithms, wherein the memory is used to store the previously detected ephemeris data for comparison with the subsequently detected ephemeris data and the digital comparator is used to compare the previously detected and subsequently detected ephemeris data.

The method described may be used for real-time detection of GNSS spoofing or as a redundancy to ensure security and integrity in the context of safety-critical automated driving functions and in combination with other security measures.

It is preferable if the detected ephemeris data is stored in a memory for comparison with the ephemeris data of the same GNSS satellite detected in a subsequent time step.

The memory may be, for example, RAM (Random Access Memory) which can store the ephemeris data quickly and for a short time to perform the described method. This is particularly advantageous for real-time detection of GNSS spoofing.

Here, for example, the ephemeris data detected in step a) can be stored in a RAM and later read out of the RAM in step c) for comparison with the ephemeris data detected in step b).

It is contemplated that the ephemeris data detected in step a) may be replaced in the RAM by the ephemeris data detected in step b) after the ephemeris data detected in step a) has been read out of the RAM, so no large memory space is required.

It is also contemplated that the memory may be an external memory, for example a flash memory, if the method described is performed as redundancy and routine.

It is preferable if, in step c), the ephemeris data detected in step a) is compared with the ephemeris data detected in step b) bit by bit. In this case, a digital comparator can be used, wherein the two ephemeris data decoded in binary codes can each be input into the comparator and compared bit by bit. The comparator can be an identity comparator, for example, which can test two bits for equality, e.g. using an XNOR gate.

One such XNOR gate-based comparator is very easy to set up on the hardware side. In the simplest case, this only requires two inputs and one output. The ephemeris data from step a) and step b) can be input via an input to the comparator, wherein a high level (=1) or a low level (=0) is indicated at the output, and wherein the high level corresponds to equality and the low level corresponds to the deviation. Once a low level is detected at the output of the comparator, the localization system may immediately take further action. No complex algorithms are required.

It is preferred if in step d) the GNSS spoofing is detected taking into account the validity period of the ephemerides of the same GNSS satellite.

Because the ephemeris data of each GNSS satellite is regularly updated. Even if a deviation occurs between both ephemeris data, one GNSS navigation message may be transmitted prior to an update and the other GNSS navigation message may be transmitted after updating the ephemeris data.

It is therefore advantageous if the validity period of the ephemerides can be tested before step d). It may also be possible that the validity period is not checked until a deviation between the ephemeris data from step a) and step b) occurs.

The deviation between the ephemeris data from step a) and step b) within the validity period may indicate a GNSS spoofing threat. As the first measure, it is preferred if the ephemeris data detected in step a) and the ephemeris data detected in step b) are removed from the current localization calculations. Thus, a current incorrect position determination can be avoided. It is particularly preferable that the affected GNSS satellite is no longer considered for localization prior to the GNSS spoofing threat being lifted. Instead, other GNSS satellites of the same GNSS are preferably used by the localization system for localization.

It is also preferred if localization calculations are restarted when a GNSS spoofing threat is detected in step d). Thus, the localization system may use other GNSS satellites of the same GNSS system to perform localizations or switch to a new GNSS system (e.g., from GPS to Galileo). Such a change may make it be possible to perform correct positioning again, as a spoofer does not normally simulate several GNSS simultaneously or is not even able to do so.

It is preferable if a control device for the GNSS receiver is configured to perform the described method.

It is preferred if a computer program is used to carry out a method described here. In other words, this relates in particular to a computer program (product) comprising commands which, when the program is executed by a computer, prompt said computer to perform a method described herein.

Here, a machine-readable storage medium on which the computer program is stored should be described. The machine-readable storage medium is typically a computer-readable data carrier.

It is also preferred if the localization system for a vehicle is configured to perform a method described here.

Moreover, a method for operating the localization system for a vehicle, comprising at least the steps of:
tracking at least one GNSS satellite and detecting ephemeris data of the at least one GNSS satellite in a time step as well as storing said ephemeris data in a memory,
ii) detecting ephemeris data of the at least one GNSS satellite in a subsequent time step,
iii) reading out the ephemeris data detected in step i) from the memory and comparing the ephemeris data detected in step i) with the ephemeris data detected in step ii) bit by bit, and
iv) taking security measures if the ephemeris data detected in step i) and in step ii) deviate from each other.

It is preferred if at least step i) to step iii) are performed repeatedly at regular intervals during operation of the localization system in order to permanently monitor whether spoofing could have occurred using the described method.

The solution presented here and its technical environment are explained in more detail in the following with reference to the figures. It should be noted that the invention is not intended to be limited by the exemplary embodiments shown. In particular, unless explicitly stated otherwise, it is also possible to extract partial aspects of the facts explained in the figures and to combine them with other components and/or insights from other figures and/or the present description. Shown schematically are:

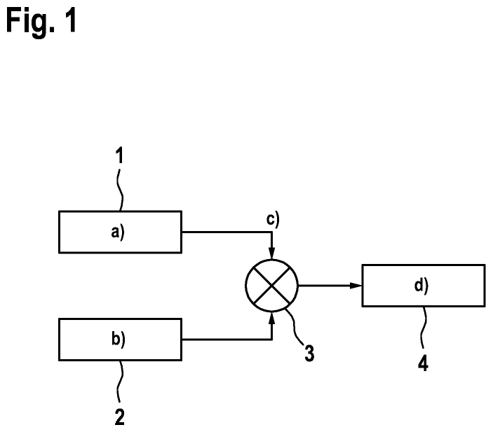

FIG. 1 a block diagram of the described method.

FIG. 1 schematically shows a block diagram of the described method. The ephemeris data or almanac data 1 detected in step a) and the ephemeris data or almanac data 2 detected in step b) are compared by a digital comparator 3 in step c) bit by bit. A potential GNSS spoofing threat may be detected based on the comparison result.

The ephemeris data or almanac data 1 detected in step a) can be stored in a memory (not shown) and read out from the memory again at a later time for comparison with the ephemeris data or almanac data 2 detected in step b). The ephemeris data or almanac data 2 detected in step b) can also be stored in the memory for comparison with the ephemeris data or almanac data detected in a subsequent time step and read out from it again.

With the described method, GNSS spoofing scenarios, such as transition from spoofing to non-spoofing and transition from non-spoofing to spoofing can be detected. Preferably, the control unit 4 associated with the localization system performs the following steps if the ephemeris data or almanac data 1 detected in step a) and the ephemeris data or almanac data 2 detected in step b) deviate from each other.
I. Removing the ephemeris data or almanac data 1, 2 detected in step a) and in step b) from the current localization calculations,
II. Not considering the affected GNSS satellite for localization calculations before the GNSS spoofing threat is lifted
III. Restarting localization calculations

In order to perform the described method, it only requires an additional memory, an additional digital comparator, and a software adjustment without complex algorithms, wherein the memory is used to store the previously detected ephemeris data or almanac data for comparison with the subsequently detected ephemeris data or almanac data and the digital comparator is used to compare the previously detected and subsequently detected ephemeris data or almanac data.

The method described may be used for real-time detection of GNSS spoofing or as a redundancy to ensure security and integrity in the context of safety-critical automated driving functions and in combination with other security measures.

1. A method for detecting global navigation satellite system (“GNSS”) spoofing in a GNSS receiver of a localization system, comprising:
a) detecting ephemeris data or almanac data of a GNSS satellite in a time step;
b) detecting ephemeris data or almanac data of the same GNSS satellite in a subsequent time step;
c) comparing the ephemeris data or almanac data detected in step a) with the ephemeris data or almanac data detected in step b), and
d) detecting GNSS spoofing when the ephemeris data or almanac data detected in step a) and in step b) deviate from each other.

2. The method according to claim 1, wherein:
a time stamp included in the ephemeris data or almanac data detected in step a) is also determined in step a),
a time stamp included in the ephemeris data or almanac data detected in step b) is also determined in step b),
in step d), as an additional condition for the GNSS spoofing, it is checked whether the time stamp determined in step a) and the time stamp determined in step b) match.

3. The method according to claim 1, wherein the detected ephemeris data from step a) are stored in a memory for comparison with the ephemeris data of the same GNSS satellite detected in the subsequent time step of step b).

4. The method according to claim 1, wherein in step c) the ephemeris data or almanac data detected in step a) and the ephemeris data or almanac data detected in step b) are compared with each other bit by bit.

5. The method according to claim 1, wherein in step d) the GNSS spoofing is detected based on a validity period of the ephemerides or almanac data of the GNSS satellite.

6. The method according to claim 1, wherein the GNSS satellite is not tracked when the ephemeris data or almanac data detected in step a) and in step b) deviate from each other.

7. The method according to claim 1, wherein the ephemeris data or almanac data detected in step a) and/or the ephemeris data or almanac data detected in step b) are removed from current localization calculations when the ephemeris data or almanac data detected in step a) and in step b) differ from each other.

8. The method according to claim 1, wherein localization calculations are restarted when the ephemeris data or almanac data detected in step a) and in step b) deviate from each other.

9. A control unit for a GNSS receiver configured to perform a method according to claim 1.

10. The method according to claim 1, wherein a computer program is configured to perform the method.

11. A non-transitory machine-readable storage medium on which the computer program according to claim 10 is stored.

12. A localization system for a vehicle, which localization system is configured to perform a method according to claim 1.
